(19) United States
(12) Patent Application Publication
(10) Pub. No.: US 2018/0027962 A1
(43) Pub. Date: Feb. 1, 2018

(54) ESSENTIAL OIL BOTTLE RACK

(71) Applicant: John Scott Benz, Venice, FL (US)

(72) Inventor: John Scott Benz, Venice, FL (US)

(21) Appl. No.: 15/660,461

(22) Filed: Jul. 26, 2017

Related U.S. Application Data
(60) Provisional application No. 62/366,810, filed on Jul. 26, 2016.

(51) Int. Cl. A47B 73/00; B67D 3/00; A47G 23/02

(52) U.S. Cl. CPC A47B 73/00; A47G 23/0241; B67D 3/0029; B67D 3/00; A47G 23/02

(57) ABSTRACT

An essential oil bottle rack. The essential oil bottle rack includes a platform having an upper surface opposite a lower surface. The lower surface may be substantially planar. The upper surface may be substantially planner with a plurality of recesses. Each of the recesses include a large diameter slot and a small diameter slot.

### CROSS-REFERENCE TO RELATED APPLICATION

This application claims the benefit of priority of U.S. provisional application No. 62/366,810, filed Jul. 26, 2016, the contents of which are herein incorporated by reference.

### BACKGROUND OF THE INVENTION

The present invention relates to storing essential oils and, more particularly, to an essential oil bottle rack.

Essential oils are a concentrated hydrophobic liquid containing volatile aroma compounds from plants. Essential oils are also known as volatile oils, ethereal oils, aetherolea, or simply as the oil of the plant from which they were extracted, such as oil of close. An oil is “essential” in the sense that it contains the “essence of” the plant's fragrance—the characteristic fragrance of the plant from which it is derived.

Essential oil bottles come in two different sizes. Therefore, storing and organizing the different sized bottles in an aesthetically pleasing manner is a challenge.

As can be seen, there is a need for an essential oil rack that contains essential oil bottles in an organized manner.

### SUMMARY OF THE INVENTION

In one aspect of the present invention, an essential oil bottle rack comprises: a platform comprising an upper surface opposite a lower surface, the upper surface comprising a plurality of recesses, wherein each of the plurality of recesses are defined by: a base horizontally disposed; a lower inner edge extending vertically from the base and defining a cylindrical shape; an inner rim extending horizontally from the lower inner edge; and an upper inner edge extending vertically from the inner rim and defining a cylindrical shape, wherein a diameter of the cylindrical shape of the lower inner edge is smaller than a diameter of the cylindrical shape of the upper inner edge.

In another aspect of the present invention, a method of organizing at least one large diameter essential oil bottle and at least one small diameter essential oil bottle, the method comprises the steps of: providing an essential oil bottle rack comprising: a platform comprising an upper surface opposite a lower surface, the upper surface comprising a plurality of recesses, wherein each of the plurality of recesses are defined by: a base horizontally disposed; a lower inner edge extending vertically from the base and defining a cylindrical shape; an inner rim extending horizontally from the lower inner edge; and an upper inner edge extending vertically from the inner rim and defining a cylindrical shape, wherein a diameter of the cylindrical shape of the lower inner edge is smaller than a diameter of the cylindrical shape of the upper inner edge; placing the at least one small diameter essential oil bottle within one of the plurality of recesses, wherein a bottom of the at least one small diameter essential oil bottle rests on the base; placing the at least one large diameter essential oil bottle within another of the plurality of recesses, wherein a bottom of the at least one large diameter essential oil bottle rests on the inner rim.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention;

FIG. 2 is an exploded view of an embodiment of the present invention;

FIG. 3 is a section detail view of an embodiment of the present invention; and

FIG. 4 is a perspective view of an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

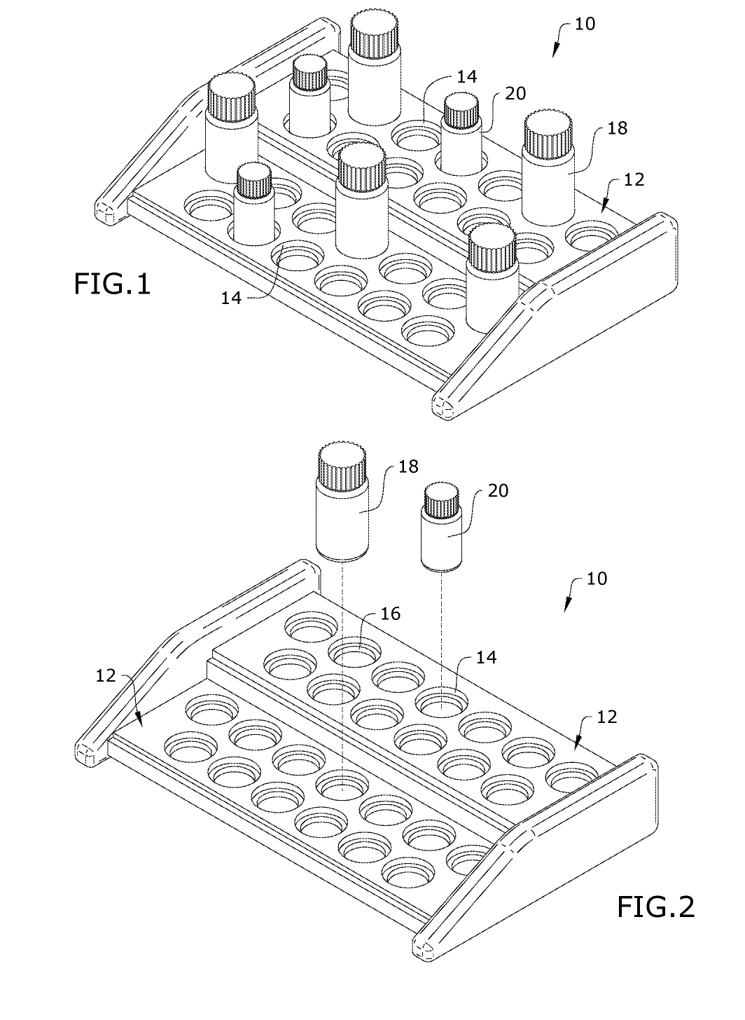

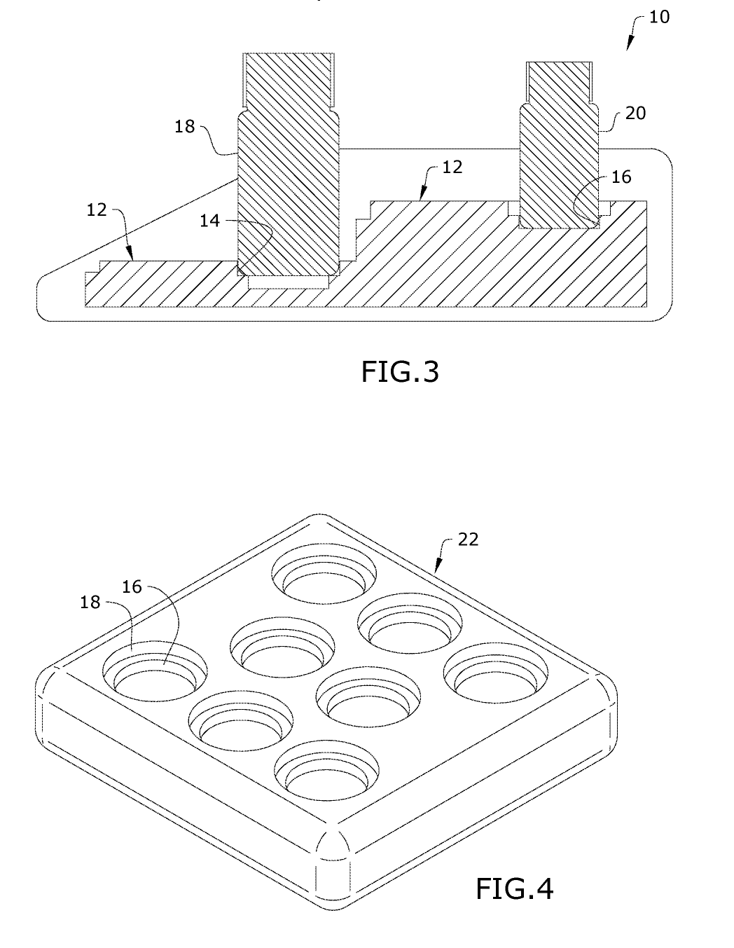

Referring to FIGS. 1 through 4, the present invention includes an essential oil bottle rack 10. The essential oil bottle rack 10 includes a platform 12 having an upper surface opposite a lower surface. The lower surface may be substantially planar. The upper surface may be substantially planar with a plurality of recesses 14, 16. Each of the recesses include a large diameter slot 14 and a small diameter slot 16.

The small diameter slot 16 is defined by a horizontally disposed base and a lower inner edge extending vertically from the base. The lower inner edge defines a cylindrical shape. The large diameter slot 14 is defined by an inner rim extending horizontally from the lower inner edge and an upper inner edge extending vertically from the inner rim. The upper inner edge defines a cylindrical shape.

The present invention is used to organize large diameter essential oil bottles 18 and small diameter essential oil bottles 20. The small diameter essential oil bottles 20 fit within the small diameter slot 16. Therefore, a bottom of the small diameter essential oil bottle 20 rests on the base of the recess 14, 16. The large diameter essential oil bottle 18 fits within the large diameter slot 14. Therefore, a bottom of the large diameter essential oil bottle 18 rests on the inner rim of the recess 14, 16.

In certain embodiments, the small diameter slot 16 may include a diameter of about ¾^{th} of an inch up to about 1 inch. For example, the small diameter slot 16 may include a diameter of about ⅞^{th} of an inch. The large diameter slot 14 may include a diameter of about 1 and 1/16^{th} of an inch up to about 1 and ¼^{th} of an inch. For example, the large diameter slot 14 may be about 1 and ⅛^{th} of an inch. The recesses 14, 16 may be evenly spaced apart on the platform 12 to provide a uniform appearance.

The present invention may include different configurations. For example, the essential oil rack 10 of FIGS. 1 through 3 may include a lower platform, an upper platform and a riser extending from the lower platform to the upper platform. The essential oil rack 10 may further include sidewalls attached to opposing sides of the platform 12, forming legs to elevate the platform 12 above a surface the essential oil rack 10 is resting. Alternatively, the essential oil rack 22 of FIG. 4 may include a single platform forming a square shaped block.

A method of organizing at least one large diameter essential oil bottle and at least one small diameter essential oil bottle may include the following steps: providing the essential oil bottle rack mentioned above; placing a small diameter essential oil bottle within one of the plurality of recesses, wherein a bottom of the at least one small diameter essential oil bottle rests on the base; placing the at least one large diameter essential oil bottle within another of the plurality of recesses, wherein a bottom of the at least one large diameter essential oil bottle rests on the inner rim.

It should be understood, of course, that the foregoing relates to exemplary embodiments of the invention and that modifications may be made without departing from the spirit and scope of the invention as set forth in the following claims.

What is claimed is:

1. An essential oil bottle rack comprising:
a platform comprising an upper surface opposite a lower surface, the upper surface comprising a plurality of recesses, wherein each of the plurality of recesses are defined by:
a base horizontally disposed;
a lower inner edge extending vertically from the base and defining a cylindrical shape;
an inner rim extending horizontally from the lower inner edge; and
an upper inner edge extending vertically from the inner rim and defining a cylindrical shape, wherein
a diameter of the cylindrical shape of the lower inner edge is smaller than a diameter of the cylindrical shape of the upper inner edge.

2. The essential oil bottle rack of claim 1, wherein the platform comprises a lower platform, an upper platform and a riser extending from the lower platform to the upper platform, wherein each of the lower platform and the upper platform comprises the plurality of recesses.

3. The essential oil bottle rack of claim 1, wherein the plurality of recesses are evenly spaced apart.

4. A method of organizing at least one large diameter essential oil bottle and at least one small diameter essential oil bottle, the method comprising the steps of:
providing an essential oil bottle rack comprising:
a platform comprising an upper surface opposite a lower surface, the upper surface comprising a plurality of recesses, wherein each of the plurality of recesses are defined by:
a base horizontally disposed;
a lower inner edge extending vertically from the base and defining a cylindrical shape;
an inner rim extending horizontally from the lower inner edge; and
an upper inner edge extending vertically from the inner rim and defining a cylindrical shape, wherein
a diameter of the cylindrical shape of the lower inner edge is smaller than a diameter of the cylindrical shape of the upper inner edge;
placing the at least one small diameter essential oil bottle within one of the plurality of recesses, wherein a bottom of the at least one small diameter essential oil bottle rests on the base;
placing the at least one large diameter essential oil bottle within another of the plurality of recesses, wherein a bottom of the at least one large diameter essential oil bottle rests on the inner rim.

5. The method of claim 4, wherein the platform comprises a lower platform, an upper platform and a riser extending from the lower platform to the upper platform, wherein each of the lower platform and the upper platform comprises the plurality of recesses.

6. The method of claim 4, wherein the plurality of recesses are evenly spaced apart.
